(19) United States
(12) Patent Application Publication
(10) Pub. No.: US 2007/0195108 A1
(43) Pub. Date: Aug. 23, 2007

(54) PHOTOGRAPHIC DEVICE WITH IMAGE GENERATION FUNCTION

(75) Inventor: Hiroyuki FURUMOCHI, Tokyo (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/676,732

(22) Filed: Feb. 20, 2007

(30) Foreign Application Priority Data
Feb. 21, 2006 (JP) 2006-043977

(51) Int. Cl. G09G 5/02

(52) U.S. Cl. 345/589; 348/E05.047

(57) ABSTRACT

A photographic device includes a moving image generator, an image display, an image memory, and an image size adjuster. The moving image generator generates a moving image. The image display displays the moving image. The moving image is stored in the image memory. The image size adjuster adjusts the image size of a moving image displayed on the image display, so that the image size of a moving image which is to be stored in the image memory is larger than that of a moving image which is not to be stored in the image memory.

### BACKGROUND OF THE INVENTION

1. Field of the Invention

The present invention relates to photographic devices having image generation function, especially to those that can display and store generated images.

2. Description of the Related Art

In photographic devices such as digital cameras, generally, generated moving images are displayed on a monitor. A user can select images to be stored in a storage medium and so on, while watching the moving images are displayed on the monitor. The quality and frame rate of images to be stored are identical to those of images displayed on the monitor that are not to be stored, if a user does not manually adjust the image frequency or quality while operating the photographic device.

Generally, it is desirable for a moving image which is to be stored to be of higher quality than that which is only to be displayed on a monitor and not to be stored. If the image quality of a moving image to be stored and that of a moving image not to be stored are the same, certain problems may occur. For example, the image quality of a stored image may not be high enough, or the image quality of a non-stored image may be unnecessarily high, unfavorably increasing the load required for processing the non-stored image.

For a moving image which is only displayed but not stored, the ability to follow a moving subject is important, so that the frame rate of such a moving image is preferably higher than that of a moving image being stored it has been displayed. If the frame rate of a moving image which is not to be stored but only displayed, and that of a moving image which is to be stored, are the same, such problems may occur. That is, an image displayed on a monitor may not be able to follow the movement of a subject, or a limited storage capacity of an image memory will not be used efficiently, because an image of unnecessarily high quality is stored in the memory.

On the other hand, operations for adjusting the quality or the frame rate of an image by a user while the user is seeking a subject can lower the operability of a camera.

### SUMMARY OF THE INVENTION

Therefore, an objective of the present invention is to provide a photographic device that can automatically adjust the quality of an image and so on, in accordance with whether a displayed moving image is to be stored or not.

A first photographic device, according to the present invention, includes a moving image generator, an image display, an image memory, and an image size adjuster. The moving image generator generates a moving image. The image display displays the moving image. The moving image is stored in the image memory. The image size adjuster adjusts the image size of a moving image displayed on the image display, so that the image size of a moving image which is to be stored in the image memory, is larger than that of a moving image which is not to be stored in the image memory.

A second photographic device, according to the present invention, includes an imaging device, an image signal reader, an image generator, and a commander. The imaging device generates image signals. The image signal reader reads the image signals from the imaging device. The image generator generates an image based on the image signals read by the image signal reader. The commander commands the image to be stored. The image signal reader reads the image signals in a first mode when storage of the image is not commanded so that the image generator generates a first image; and the image signal reader reads the image signals in a second mode when storage of the image is commanded so that the image generator generates a second image. The image size of the second image is larger than the image size of the first image.

### BRIEF DESCRIPTION OF THE DRAWINGS

The present invention will be better understood from the description of the preferred embodiment of the invention set forth below, together with the accompanying drawings, in which:

FIG. 1 is a block diagram of a digital camera of an embodiment of the present invention;

FIG. 2 is a flowchart representing a moving image storage routine of the embodiment;

FIG. 3 is a flowchart representing a moving image storage routine of a comparative example; and

FIG. 4 is a timing chart illustrating reading image signals in a moving image mode.

### DESCRIPTION OF THE PREFERRED EMBODIMENT

Hereinafter, the embodiment of the present invention is described with reference to the attached drawings.

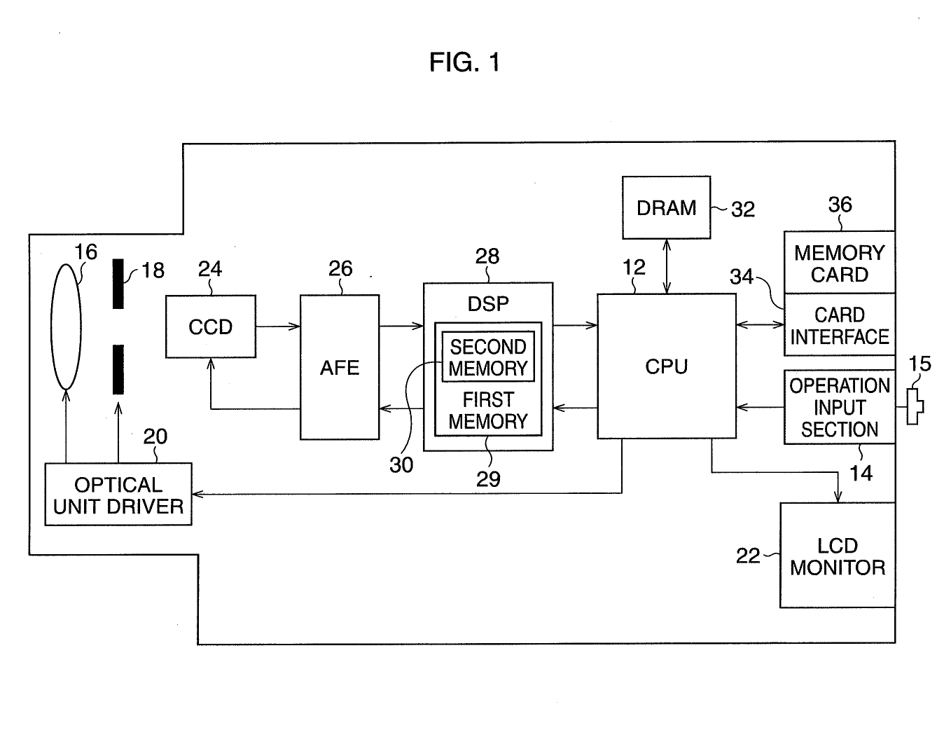

As shown in FIG. 1, in a digital camera, a CPU 12 that controls entire the digital camera is provided. To the CPU 12, an operation input section 14 is connected, and signals corresponding to the operation of the operation input section 14 are transmitted to the CPU 12. In the digital camera, various modes, including a moving image mode where a subject is photographed and a moving image is generated, can be set by the operation of the operation input section 14.

A liquid crystal display (LCD) monitor 22 to display an image is provided on the digital camera. When the moving image mode is set, as explained below, the generated moving image is first displayed as a through image on the LCD monitor 22, before being stored upon a user's command.

First, reflected light from a subject passes through a photographing lens 16, and reaches a CCD 24 (a moving image generator, an imaging device), where a charge corresponding to a subject image is generated. Then the charge read from the CCD 24, that is, image signals, are transmitted to an AFE (analog front end) 26. In the AFE 26, various processes such as noise reduction and digitization are carried out on the image signals. The digitized image signals are then transmitted to DSP (digital signal processor) 28.

In the DSP 28, various processes such as white balance adjustment and gamma adjustment are carried out on the image signals, after which luminance signals and color-difference signals are then generated. Generated luminance signals and color-difference signals, which are image data, are transmitted to the LCD monitor 22. As a result of this, a subject image is displayed as a through image on the LCD monitor 22. Note that, in the DSP 28 a first memory 29 and a second memory 30, in which image signals are temporally stored for the above explained process, are provided.

In the AFE 26, one of the following two modes can be selected for driving the CCD 24. Drive mode A has an image size of 1088×408 (pixels) and frame rate of 30 (fps), whereas drive mode B has an image size of 1088×816 (pixels) and frame rate of 20 (fps). Either drive mode A or B is selected based on the command from the DSP 28.

When a release button 15 provided in the operation input section 14 is partially depressed, a photometry switch (not shown) is turned on. When the photometry switch is turned on, photometric operations for metering a subject by a metering section (not shown), and distance-measuring operations for measuring the distance to a subject by a distance measuring section (not shown) are carried out. Obtained luminance data and distance data are then transmitted to the CPU 12, which controls an optical unit driver 20 based on the distance data so that the photographing lens 16 is moved to the focused position, and calculates an exposure value based on the luminance data.

When the release button 15 (a commander) is fully depressed, a release switch (not shown) is turned on, and a shutter speed of a shutter (not shown) and an aperture value of a diaphragm 18 are set to predetermined values, based on the calculated exposure value. Next, the diaphragm 18 is opened the predetermined amount, and the shutter is opened for the predetermined time, so that the CCD 24 is exposed and a moving image is generated.

Due to the operation of the release button 15, as explained above, the generated moving image is stored in a DRAM 32. That is, when the CPU 12 receives command signals from the operation input section 14 to store a moving image, the CPU 12 transmits image data generated in the DSP 28 not only to the LCD monitor 22, but also to the DRAM 32, where the generated moving image is stored. Further, if a memory card 36 is installed in the digital camera via a card interface 34, the moving image is also stored in the memory card.

Note that the DSP 28 transmits signals for changing the frame rate and image size (the pixel number of an image) of a moving image to the AFE 26. The AFE 26 adjusts the frame rate and image size of a moving image by changing the method of reading the image signals from the CCD 24, based on the signals received from the DSP 28.

The CPU 12 controls image signals to be temporally stored in either the first memory 29 or the second memory 30. That is, as explained below, the CPU 12 controls image signals to be stored temporally in the first memory 29 when a moving image is to be stored ultimately, and controls image signals to be stored temporally in the second memory 30 when a moving image will not be stored ultimately.

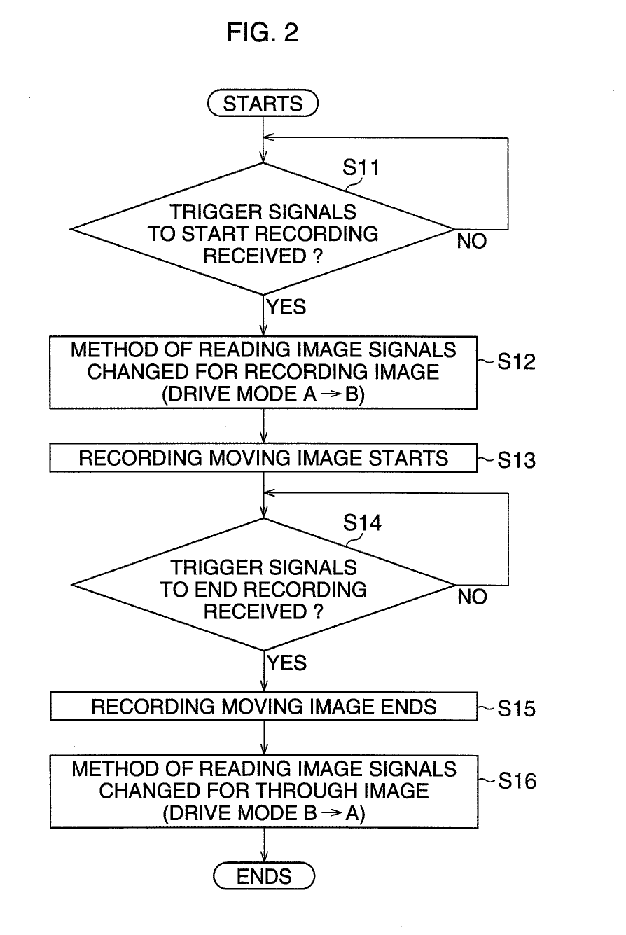

The moving image storage routine represented in FIG. 2, starts when the moving image mode is set. At step S11, it is determined whether the release switch is turned on or not, that is, whether or not the CPU 12 receives the trigger signals to start recording a moving image. When it is determined that the release switch is turned on and the CPU 12 receives the trigger signals, the process proceeds to step S12.

At step S12, the method of reading image signals from the CCD 24 is changed by the AFE 26; that is, the drive mode of the CCD 24 is switched from drive mode A to drive mode B. Under drive mode B compared to drive mode A, the image size of a moving image to be stored becomes larger, and the frame rate of a moving image to be stored becomes lower, than those of a moving image which is displayed as a through image but not stored in the DRAM 32 and so on. The process then proceeds to step S13. Note that a moving image which is not stored in the DRAM 32 and so on includes a moving image which is only displayed on the LCD monitor 22 as a through image, or a moving image which is not yet, but eventually will be stored in the DRAM 32 and so on.

At step S13, recording a moving image starts. A moving image is displayed on the LCD monitor 22 with the frame rate that was set at step S12, and is stored in the DRAM 32 and so on with the image size that was also set at step S12. When a moving image to be stored is processed in the DSP 28 as explained above, the first memory 29 is used. That is, the memory used for processing an image is switched from the second memory 30 to the first memory 29 under the control of the CPU 12.

The memory is switched because the storage capacity of the first memory 29 is larger than that of the second memory 30, and more suitable for processing a large image which is to be stored, than the second memory 30, which is used for processing a moving image that is only displayed as a through image. As a result, efficient image processing in the DSP 28 is possible.

At step S14, whether the release switch is turned on or not is again determined, that is, whether the CPU 12 does or does not receive the trigger signals to stop recording a moving image. When it is determined that the release switch is turned on and the CPU 12 receives the trigger signals, the process proceeds to step S15. At step S15, recording a moving image ends, and the memory that is used for image signal processing in the DSP 28 is switched from the first memory 29 to the second memory 30, under the control of the CPU 12. The process then proceeds to step S16.

At step S16, the AFE 26 resets the method of reading image signals from the CCD 24 to the previous one used before recording an image; that is, the drive mode of the CCD 24 is switched from drive mode B to drive mode A. Therefore, the original method of reading image signals that was in place before being changed at step S12 is adopted once again, so that a through image having a smaller image size and higher frame rate than those of a recorded moving image is displayed on the LCD monitor 22. At this point, the moving image storage routine ends.

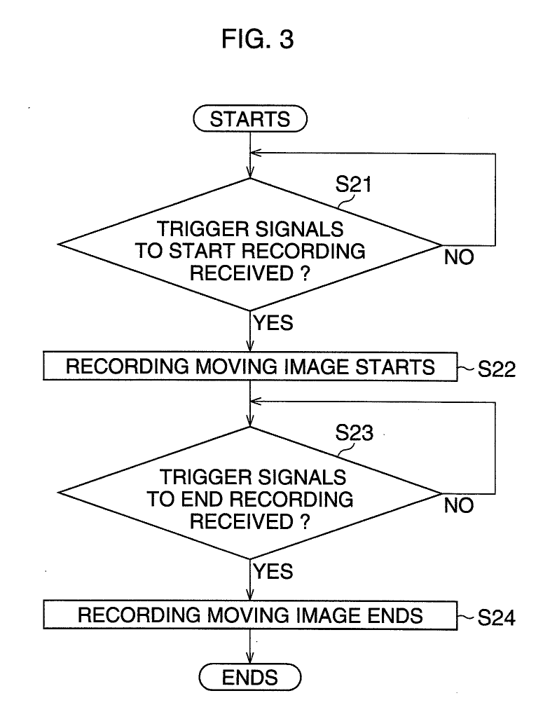

On the other hand, in a moving image storage routine of a comparative example represented in FIG. 3, steps corresponding to step S12 and S16 are not carried out. That is, the method of reading image signals from the CCD 24 is not changed, and the image size and the frame rate of an image are not controlled.

Therefore, in a digital camera of the comparative example, when the method of reading image signals is set to be suitable for storing a moving image, certain problems that are explained below may occur. One problem occurs when the load for processing an image is increased because the quality of a moving image is unnecessarily high due to the fact the moving image is intended only for display, not storage. Another problem occurs when the frame rate is set so low that the subject cannot be followed efficiently.

Further, in a digital camera of the comparative example, when the method of reading image signals is set to be suitable for a through image which is to be only displayed and not stored, problems explained below may also occur. That is, a problem where the quality of a stored image is too low due to insufficient image size, or another problem where the limited storage capacity is not used efficiently because an image of unnecessarily high quality is stored in the DRAM 32 and so on.

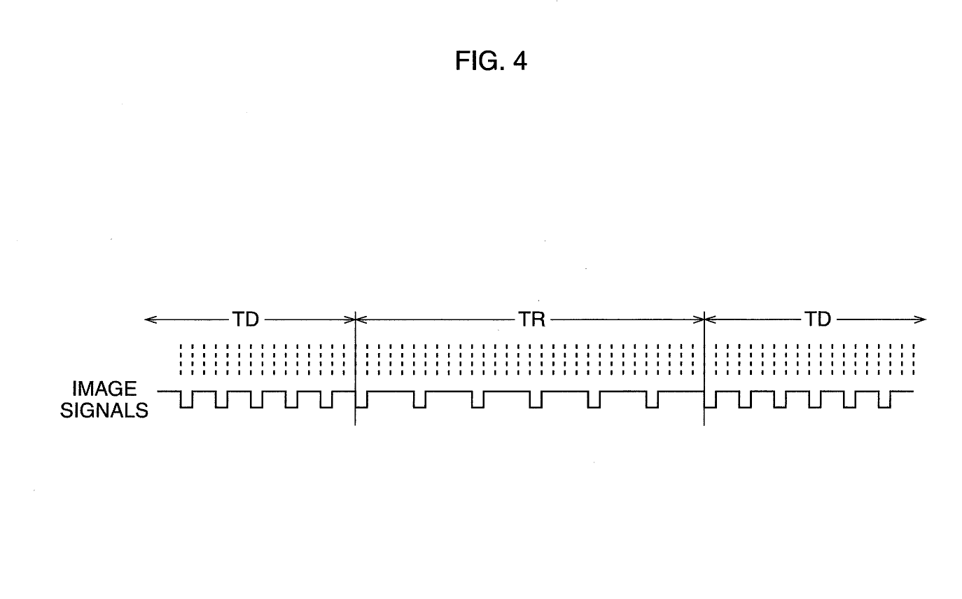

In a first period TD of the moving image mode (see FIG. 4), the release switch is off state so that a moving image is not stored and is only displayed on the LCD monitor 22. At the time, the frame rate is 30 (fps) and image signals are read per every 33 (ms), and the image size is 1088×408 (pixels). Note that distances between neighboring broken lines represent about 10 (ms).

When the release switch is turned on, the second period TR starts. At the time, the method of reading image signals from the CCD 24 is changed for storing a moving image, so that the frame rate is lowered to 20 (fps), and image signals are read per every 50 (ms). Note that the frame rate can be adjusted by inputting order signals via the operation input section 14. Therefore, a frame rate other than 20 (fps) can be set when a moving image is stored, that is, during the second period TR.

The image size of a moving image which is stored during the second period TR, is set at 1088×816 (pixels). Therefore, in a case where an image is displayed on the LCD monitor 22 with the size of 1088×640 (pixels) in the second period TR, a thinning process is carried out to a moving image which is stored and which has the size of 1088×816 (pixels) being larger than the 1088×640 (pixels) display limitation of the LCD monitor 22. On the other hand, in the first period TD, an interpolation process is carried out to the above explained moving image which is only displayed as a through image and which has the size of 1088×408 (pixels) being smaller than the 1088×640 (pixels) display limitation of the LCD monitor 22.

That is, in the first period TD, the interpolation process is undertaken for the image of 1088×408 (pixels) by the DSP 28 so that the image of 1088×640 (pixels) is generated for display on the LCD monitor 22. On the other hand, in the second period TR, the thinning process is undertaken for the image of 1088×816 (pixels) by the DSP 28 so that the image of 1088×640 (pixels) is generated for display. Therefore, it is clear that the quality of a moving image which is displayed on the LCD monitor 22 in the second period TR, when recording the moving image is commanded, is higher than one which is displayed on the LCD monitor 22 in the first period TD, when recording the moving image is not commanded; that is, the quality of a moving image which is stored is higher than that of a moving image which is not stored.

In the digital camera of this embodiment, as explained above, the quality and frame rate of an image are adjusted automatically and appropriately, in accordance with whether a displayed moving image is stored or not. That is, when a generated moving image is stored, the image quality is improved. On the other hand, when a generated moving image is not stored, the frame rate thereof is raised to be higher than that of a moving image which is stored, so that a moving image which has high responsiveness and visibility can be displayed.

In this embodiment, the image quality and frame rate are adjusted in a digital camera, however, they may be adjusted in other photographing devices which can generate a moving image. For example, the image quality and frame rate may be adjusted similarly in the embodiment of a video camera, a cellular phone having a moving image generation function, and other devices. Further, the image size and method of reading the image signals for a still image may also be controlled similarly to those of a moving image.

Only one of either the image quality or frame rate may be adjusted in accordance with whether a moving image is stored or not. That is, when a moving image is stored, only the image size may be adjusted to be larger than that of a non-stored moving image, and when a moving image is not stored and is only displayed as a through image, only the frame rate may be adjusted to be higher than that of a stored moving image.

Values of the image quality and frame rate are not limited to those exemplified in the embodiment. For example, in terms of the image size, a stored moving image may have a larger number of pixels in both the horizontal direction and the vertical direction than those of a non-stored image. Further, a stored moving image may have a larger number of pixels in only the vertical direction than that of a non-stored image, and may have the same number of pixels as that of a non-stored image in the horizontal direction.

This invention is not limited to that described in the preferred embodiment; namely, various improvements and changes may be made to the present invention without departing from the spirit and scope thereof.

The present disclosure relates to subject matter contained in Japanese Patent Application No. 2006-043977 (filed on Feb. 21, 2006), which is expressly incorporated herein, by reference, in its entirety.

1. A photographic device comprising:
a moving image generator that generates a moving image;
an image display that displays said moving image;
an image memory in which said moving image is stored; and
an image size adjuster that adjusts the image size of said moving image that is displayed on said image display, said image size adjuster adjusting the image size of a stored moving image being larger than the image size of a non-stored moving image, said stored moving image being said moving image that is to be stored in said image memory, and said non-stored moving image being said moving image that is not to be stored in said image memory.

2. The photographic device according to claim 1, wherein said moving image generator comprises an imaging device that generates image signals, said image size adjuster adjusts the image size of said moving image by changing the method of reading said image signals from said imaging device.

3. The photographic device according to claim 1, further comprising a first memory in which said stored moving image is temporally stored, and a second memory in which said non-stored moving image is temporally stored, the storage capacity of said first memory being larger than the storage capacity of said second memory.

4. The photographic device according to claim 3, further comprising a commander that commands said image memory to store said moving image, and a memory selector that selects said first memory or said second memory in which said moving image is temporally stored, said memory selector selecting said first memory when said commander commands to store said moving image.

5. The photographic device according to claim 1, further comprising a frame rate adjuster that adjusts the frame rate of said moving image that is displayed on said image display, said frame rate adjuster adjusting the frame rate of said non-stored moving image, being higher than the frame rate of said stored moving image.

6. The photographic device according to claim 5, wherein said moving image generator comprises an imaging device that generates image signals, said frame rate adjuster adjusting the frame rate of said moving image by changing the method of reading said image signals from said imaging device.

7. A photographic device comprising:
an imaging device that generates image signals;
an image signal reader that reads said image signals from said imaging device;
an image generator that generates an image based on said image signals read by said image signal reader; and
a commander that commands said image to be stored; said image signal reader reading said image signals in a first mode when storing said image is not commanded so that said image generator generates a first image; and said image signal reader reading said image signals in a second mode when storing said image is commanded so that said image generator generates a second image, the image size of said second image being larger than the image size of said first image.

8. The photographic device according to claim 7, wherein said first image and said second image are moving images, the frame rate of said first image is higher than the frame rate of said second image.
